(19) United States
(12) Patent Application Publication
(10) Pub. No.: US 2026/0321737 A1
(43) Pub. Date: Oct. 15, 2026

(54) BATTERY UNIT AND METHODS FOR MANUFACTURING THE SAME

(71) Applicant: Millibatt, Inc., Los Angeles, CA (US)

(72) Inventors: Sohyun An, Redmond, WA (US); Kyung Rak Jang, Los Angeles, CA (US); Janet Hur, Culver City, CA (US); Leland Smith, Burbank, CA (US)

(21) Appl. No.: 19/647,671

(22) Filed: Apr. 14, 2026

Related U.S. Application Data
(60) Provisional application No. 63/788,642, filed on Apr. 14, 2025.
(60) Provisional application No. 63/881,739, filed on Sep. 15, 2025.

(51) Int. Cl. H01M 10/0587; H01M 50/107; H01M 50/403

(52) U.S. Cl. CPC H01M 10/0587; H01M 50/107; H01M 50/403

(57) ABSTRACT

An electrode-separator assembly includes: an electrode assembly; and a separator. The electrode assembly includes: a conductive substrate coated with electrode material; a first face; a second face opposite the first face; a first end defining a first serrated geometry; a second end opposite the first end and defining a second serrated geometry; a first side extending between the first end and the second end; and a second side opposite the first side. The separator includes a conformal separator coating and extends continuously: across the first face and the second face of the first electrode assembly; around the first side and the second side of the first electrode assembly; and around proximal resected regions on the first end and the second end of the first electrode assembly.

### CROSS-REFERENCE TO RELATED APPLICATIONS

This Application claims the benefit of U.S. Provisional Patent Application Nos. 63/881,739, filed on 15 Sep. 2025, and 63/788,642, filed on 14 Apr. 2025, each of which is hereby incorporated in its entirety by this reference.

This Application is related to U.S. Non-Provisional application Ser. Nos. 19/042,874 filed on 31 Jan. 2025, and Ser. No. 18/744,431 filed on 14 Jun. 2024, each of which is hereby incorporated in its entirety by this reference.

### TECHNICAL FIELD

This invention relates generally to the field of battery technologies and, more specifically, to a new and useful battery unit and methods for manufacturing the same in the field of battery technologies.

### BRIEF DESCRIPTION OF THE FIGURES

FIG. 1 is a schematic representation of a battery unit;

FIG. 2 is a flowchart representation of one variation of the battery unit;

FIGS. 3A and 3B are flowchart representations of variations of the battery unit; and

FIGS. 4A and 4B are flowchart representations of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

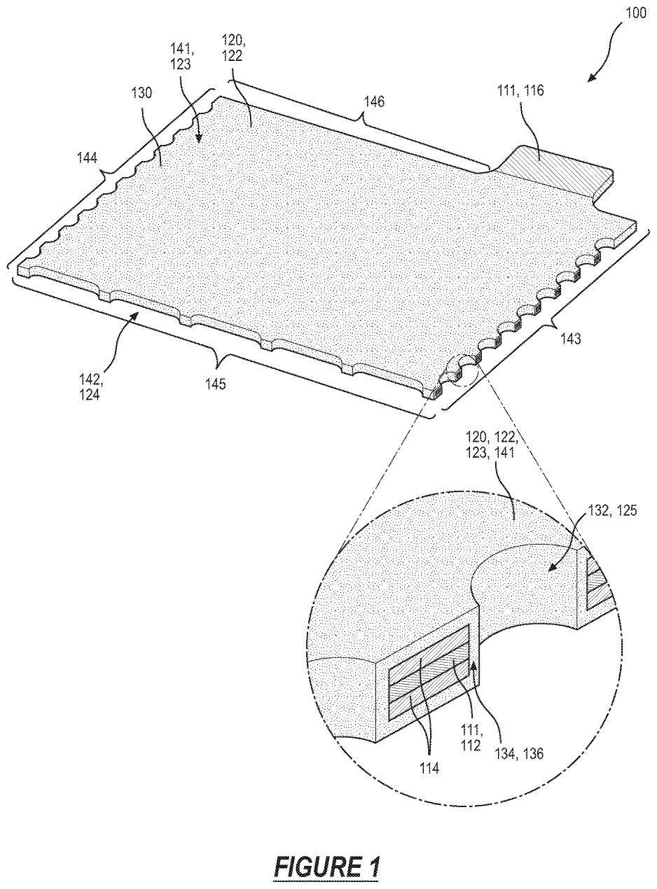

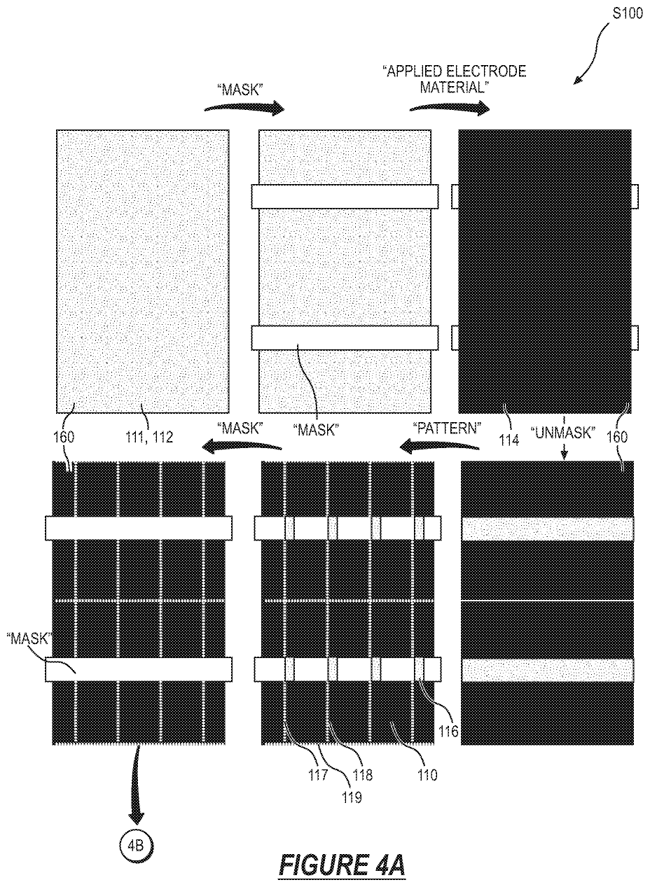

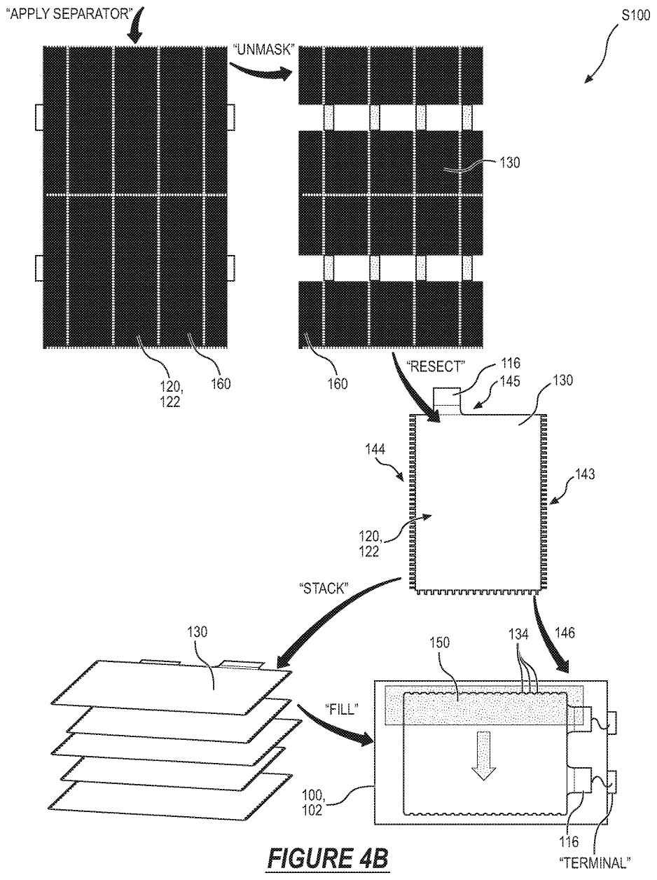

As shown in FIGS. 1, 4A, and 4B, a method S100 includes: receiving a web 160 of conductive substrate 111 (e.g., a continuous web 160 of current collector 112); coating the web 160 of conductive substrate 111 with an electrode material 114 to form a continuous web 160 of electrode assemblies 110; cutting (e.g., laser cutting, laser patterning stamping, punching) lateral rows of perforations 118 along interfaces between adjacent electrode assemblies 110 in the web 160 of electrode assemblies 110; and coating the web 160 of electrode assemblies 110 with a separator material 122 to form a web 160 of electrode-separator assemblies.

The method S100 further includes resecting (or cutting, dicing) the web 160 of electrode-separator assemblies along the lateral rows of perforations 118 to separate a set of discrete electrode-separator assemblies, wherein each discrete electrode-separator assembly defines serrated edges-including coated recessed faces and uncoated resected faces-where resected along rows of perforations 117.

The method S100 also includes: stacking the set of discrete electrode-separator assemblies into a stack of alternating anode-separator assemblies and cathode assemblies to form a battery cell; arranging the battery cell within a housing; and injecting a volume of electrolyte 150 into the housing, the volume of electrolyte 150 configured to permeate into (or “wet”) electrode material 114 (e.g., active anode or cathode material) via the uncoated resected faces along serrated edges of each electrode-separator assembly in the electrode stack.

### 1.1 Battery Unit

As shown in FIGS. 1, 2, 4A, and 4B, a battery unit 100 includes: a housing; a set of anode-separator assemblies; a set of cathode assemblies; and a volume of electrolyte 150.

The housing: defines a cavity; and includes a negative terminal and a positive terminal.

The set of anode-separator assemblies is arranged within the cavity of the housing. Each anode-separator assembly, in the set of anode-separator assemblies, includes: an anode current collector 112 (e.g., a copper sheet) including an anode tab 116 configured to electrically couple to the negative terminal of the housing; an anode material (e.g., graphite) coated over the anode current collector 112; and a separator coating 120 defining an open network of pores and encasing the anode material and the anode current collector 112.

Each anode-separator assembly, in the set of anode-separator assemblies, defines a serrated edge cut along a series of perforations 117 that previously delineated the anode-separator assembly from an adjacent anode-separator assembly in an anode-separator web 160.

The set of cathode assemblies is: arranged within the cavity of the housing; and interposed between the set of anode-separator assemblies. Each cathode assembly, in the set of cathode assemblies, includes: a cathode current collector 112 including a cathode tab 116 configured to electrically couple to the positive terminal of the housing; a cathode material (e.g., NMC, LFP, NCA, LCO) coated over the cathode current collector 112; and a separator coating 120 defining an open network of pores and encasing the cathode material and the cathode current collector 112.

(Additionally or alternatively, each cathode assembly, in the set of cathode assemblies, can define a serrated edge cut along a series of perforations 117 that previously delineated the cathode-separator assembly from an adjacent cathode-separator assembly in a cathode-separator web 160.)

The volume of electrolyte 150: is arranged within the cavity of the housing; and permeates into (or “wets”) the anode material within an anode-separator assembly by flowing into uncoated resected faces along the serrated edge of the anode-separator assembly. (The volume of electrolyte 150 can similarly permeate into (or “wet”) the cathode material within a cathode-separator assembly by flowing into uncoated resected faces along the serrated edge of the cathode assembly.)

### 1.1.1 Variation: Battery Unit

As shown in FIGS. 1, 2, 4A, and 4B, the battery unit includes: a first electrode-separator assembly; a second electrode assembly 110 arranged over the first electrode-separator assembly; and an electrolyte 150.

The first electrode-separator assembly includes: a first electrode assembly 110; and a first separator. The first electrode assembly 110 includes: a conductive substrate 111 coated with an electrode material 114; a first face 141; a second face 142 opposite the first face 141; a first end 143 defining a first serrated geometry; a second end 144 opposite the first end 143 defining a second serrated geometry; a first side 145 extending between the first end 143 and the second end 144; and a second side 146 opposite the first side 145. The first separator includes a monolithic conformal separator coating 120 and extends continuously: across the first face 141 and the second face 142 of the first electrode assembly 110; around the first side 145 and the second side 146 of the first electrode assembly 110; and around proximal resected regions on the first end 143 and the second end 144 of the first electrode assembly 110.

### 1.2 Web of Electrode-separator Assemblies

As shown in FIGS. 4A and 4B, a web 160 of electrode-separator assemblies includes: a conductive substrate 111; and a monolithic conformal separator coating 120. The conductive substrate 111: is coated with an electrode material 114; includes a continuous web 160 defining a first face 141 and a second face 142 opposite the first face 141; and includes a series of lateral rows of perforations 118 longitudinally offset by an electrode length. The monolithic conformal separator coating 120 extends continuously: between the first face 141 and the second face 142 of the web 160 of electrode assemblies 110; and through the series of lateral rows of perforations 118.

### 2. Applications

Generally, the method S100 can be executed during manufacture of a continuous (e.g., roll-to-roll) web 160 of electrode-separator assemblies separable along rows and columns of separator-coated perforations 117 to form discrete electrode-separator assemblies that can be stacked—without further electrode processing and without insertion of discrete separator films—to form a battery unit 100. The method S100 can be further executed: to resect (or cut, dice) the web 160 of electrode-separator assemblies along these perforations 117 to form these discrete electrode-separator assemblies; and to stack these discrete electrode-separator assemblies (e.g., anode-separator assemblies) with complementary electrode assemblies 110 (e.g., cathode assemblies)—without discrete separator films—to form the battery unit 100.

More specifically, the method S100 can be executed—such as on a battery manufacturing line or in a battery production facility—to: ingest a continuous web 160 (e.g., sheet, roll) of electrode assemblies 110 including a conductive substrate 111 (e.g. a current collector 112) coated on both sides with electrode material 114; perforate (e.g., via laser cutting, laser patterning) the web 160 of electrode assemblies 110 along planned cut lines between rows and columns of electrode-separator assemblies; spray-coat a separator material 122 onto both sides of the web 160 of electrode assemblies 110 to form a web 160 of electrode-separator assemblies with a monolithic conformal separator coating 120 that encapsulates the electrode assemblies 110 and these perforations 117; and then cut (e.g., laser-cut) the web 160 of electrode-separator assemblies along these perforations 117 to separate discrete electrode-separator assemblies ready for assembly into battery units 100 with minimal additional processing.

### 2.1 Electrode-separator Assembly Serrations+Separator Bridging

In particular, and as shown in FIGS. 1, 2, 3A, and 3B, resection of the web 160 of electrode-separator assemblies along rows and/or columns of circular perforations 117 yields an electrode-separator assembly exhibiting serrated edges. Each serrated edge may exhibit a series of linear segments (hereinafter “distal resected regions 134” or “uncoated resected faces”) interposed between a series of semicircular segments (hereinafter “proximal resected regions” or “coated recessed faces”), wherein these semicircular segments correspond to prior perforations 117 in the web 160 of electrode-separator assemblies, and wherein the linear segments corresponding to regions of the web 160 of electrode-separator assemblies that connected the electrode-separator assembly to an adjacent electrode-separator assembly prior to resection along these perforations 117. Thus, the monolithic conformal separator coating 120 of the electrode-separator assembly extends from a first broad face of the electrode assembly 110, across these semicircular segments on the serrated edge of the electrode-separator assembly, then across the second opposing broad face of the electrode assembly 110. The separator coating 120 on the semicircular segments can: thus function as bridges that connect larger areas of separator coating 120 extending up to the edges of the broad faces of the electrode assembly 110; prevent the separator coating 120 from separating (or “peeling back”) from the edges of the broad faces of the electrode assembly 110 both during resection of the web 160 of electrode-separator assemblies and operation of a battery unit 100 containing the electrode-separator assembly; preserve encapsulation of the electrode assembly 110 by the separator coating 120; and therefore reduce risk of shorting in a battery unit 100 that may otherwise result from exposure of the electrode or current collector 112.

Furthermore, the linear segments along the serrated edge of the electrode-separator assembly may include regions of exposed current collector 112 and electrode material 114. However, these exposed regions of current collector 112 and electrode material 114 may be both small in cross-sectional area and offset from a nearest complementary electrode in a battery by greater than (or 50-100x) the separator coating thickness, which together may be sufficient to prevent shorting between electrodes. Additionally or alternatively, the complementary electrode assembly 110 can be similarly coated with separator material 122 and can exhibit a serrated edge with linear and semicircular segments interleaved between the linear and semicircular segments of the electrode-separator assembly in a battery unit 100 in order to further isolate exposed electrode material 114 in these electrode-separator assemblies.

Therefore, pre-perforating a continuous web 160 of the electrode assembly 110 before application of the separator material 122 enables the separator material 122 to form a monolithic conformal separator coating 120 that extends through these perforations 117 to connect (or “bridge”) separator coating 120 along edges of each broad face of the web 160 of electrode-separator assemblies. Electrode-separator assemblies can thus be processed, perforated, and coated with separator material 122 en masse on a single web 160 (e.g., rather than individually). This web 160 of electrode-separator assemblies is then cut along these perforations 117 to produce individual, discrete electrode-separator assemblies: in which perforated regions of web 160 of electrode-separator assemblies become serrated edges of electrode-separator assemblies; in which separator coating 120 located in semicircular segments (“proximal resected regions,” “coated recessed faces”) of these serrated edges mechanically prevents the separator coating 120 from separating from the broad faces of its electrode assembly 110; and in which these electrode-separator assemblies are ready for assembly into batteries with no or minimal further processing.

### 2.2 Battery Unit Assembly

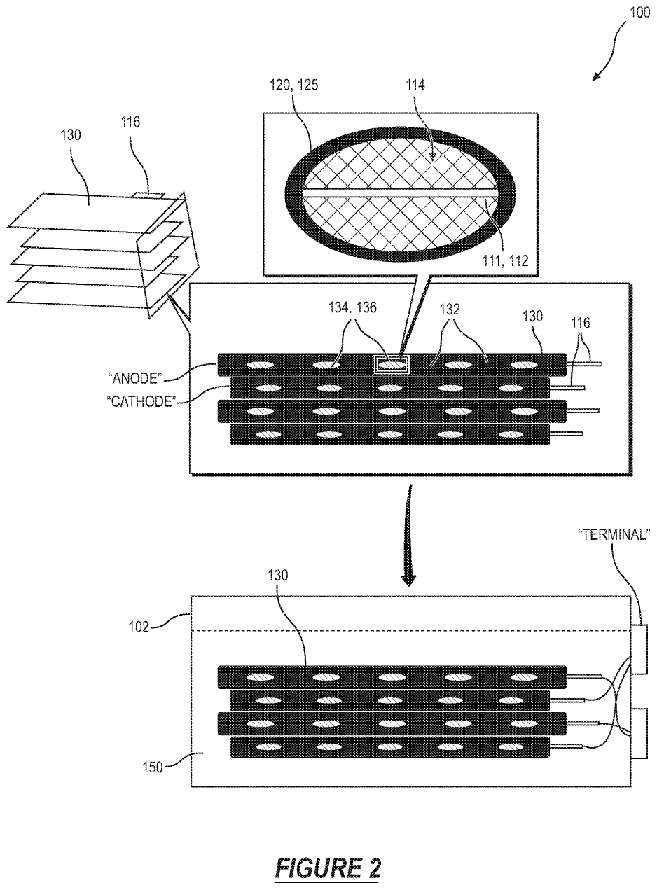

As shown in FIGS. 2 and 4B, a set of discrete electrode-separator assemblies of alternating types (e.g., anode and cathode) can then be stacked (and wound or “rolled”) to form a battery cell, which is loaded into a battery housing 102 (e.g., a rectilinear battery housing 102, a cylindrical battery housing). Tabs 116 extending from the current collectors 112 in the electrode-separator assemblies can be connected to corresponding terminals of the battery housing 102; and a volume of electrolyte 150 can be injected within the housing to wet the separator material 122 and the electrode material 114.

More specifically, the battery unit 100 includes: a housing; a set of anode-separator assemblies; a set of cathode assemblies or cathode-separator assemblies; and a volume of electrolyte 150. Each anode-separator assembly in the set of anode-separator assemblies: includes an anode assembly (e.g., a current collector 112 coated with graphite); includes a separator coating 120 encasing the anode assembly except for an anode tab 116 extending from the anode assembly; and includes serrated edges formed (e.g., laser-cut) along lateral sides of the anode-separator assembly. The serrated edges include separator-coated proximal recessed faces and uncoated distal resected faces that expose small portions of the electrode material 114 that are otherwise encapsulated by the separator coating 120.

Furthermore, the electrolyte 150 can flow laterally into electrode material 114 in an electrode-separator assembly via the linear segments (or “distal resected regions 134,” “uncoated resected faces”) along the edge of the electrode-separator assembly. These uncoated resected faces—resulting from resection of the web 160 of electrode-separator assemblies along a perforation—can therefore: function as direct pathways for electrolyte 150 to enter and wet the electrode material 114, which is predominantly (or nearly entirely) encapsulated by the separator coating 120; and thus reduce wetting time of the electrode material 114.

Therefore, the battery unit 100 can include electrode assemblies 110 that are fully coated with separator material 122 except for relatively small edge areas: that are mechanically isolated from adjacent electrodes by separator coating 120 located around but not over these small areas; and that support directly electrolyte 150 uptake into electrode material 114.

### 2.3 Disclaimer

The method S100 is described herein for production of rectangular anode-type electrode assemblies 110 and electrode-separator assemblies. However, the method S100 can be executed to produce cathode-type electrode assemblies 110 and electrode-separator assemblies.

Furthermore, the method S100 can be executed to produce electrode assemblies 110 and electrode-separator assemblies of other geometries, such as circular electrode assemblies 110 and electrode-separator assemblies in which short lateral and longitudinal tangent regions between adjacent electrode assemblies 110 and electrode-separator assembly in a continuous web 160 are perforated and interconnected by ligaments 136 that are later resected in order to release individual circular electrode-separator assemblies from the web 160. For example, such circular electrode-separator assemblies can be stacked and loaded into a cylindrical (e.g., coin cell, button cell) battery housing to form a coin cell battery unit 100.

Furthermore, the method S100 is described herein as executed to stack individual electrode-separator assemblies to form a battery cell. However, individual electrode-separator assemblies can additionally or alternatively be folded (e.g., z-folded) or manipulated in any other way to assemble the electrode-separator assembly into a battery cell.

Furthermore, the method S100 is described herein as executed to perforate the continuous web 160 of electrode assemblies 110 after application of electrode material 114 onto the current collector 112 and before application of separator material 122 over the electrode material 114. However, the continuous web 160 of conductive substrate 111 can be perforated prior to application of the electrode material 114.

The webs 160 of conductive substrate 111, electrode assemblies 110, and electrode-separator assemblies and individual electrode-separator assemblies can be configured according to these processing variations.

Furthermore, the method S100 is described herein as executed to form circular perforations in the web 160 of electrode assemblies 110. However, the method S100 can be executed to form rectangular perforations, squircle perforations, or perforations of any other geometry in the web 160 of electrode assemblies 110.

### 3. Terms

A “conductive substrate 111” is referred to herein as a section of current collector 112.

An electrode assembly 110 is referred to herein as a section of conductive substrate 111 coated with an electrode material 114.

An electrode-separator assembly 130 is referred to herein as an electrode assembly 110 coated with a monolithic conformal separator coating 120, such as a heterogenous or homogenous, single-layer or multi-layer coating.

An “end” herein refers to an edge of an electrode-separator assembly resected (or cut, diced) along a row of perforations 117 extending perpendicular to a processing direction (or “direction of flow”) of the continuous web 160 of electrode-separator assemblies.

A “side” herein refers to an edge of an electrode-separator assembly non-parallel (e.g., perpendicular) to an end of the electrode-separator assembly.

A “proximal resected region” and a “coated resected face” herein refer to a section of a serrated edge of an electrode-separator assembly that remains encased by the separator coating 120 following resection of the web 160 of electrode-separator assemblies along a perforation. A proximal resected region of a discrete electrode-separator assembly corresponds to perforations 117 in a web 160 of electrode-separator assemblies from which the electrode-separator assembly was cut.

A “distal resected region” and an “uncoated resected face” herein refer to a section of a serrated edge of an electrode-separator assembly in which the electrode assembly 110 (i.e., current collector 112 and anode material) is exposed (i.e., not coated with separator material 122). A distal resected region of a discrete electrode-separator assembly corresponds to ligaments 136 between perforations 117 in a web 160 of electrode-separator assemblies from which the electrode-separator assembly was cut.

### 4. Manufacturing System

The method S100 can be executed by a manufacturing system including: a collector web receiving station; a collector masking station; an electrode material 114 application station; a mask removal station; a patterning station; a separator application station; a resection station; a battery assembly station; and an injection station.

### 4.1 Collector Web Receiving Station

The collector web receiving station can include a collector reel configured to receive a continuous roll (or “web”) of current collector 112.

### 4.2 Collector Masking Station

The collector masking station can include a mask applicator configured to apply a masking to the web 160 of current collector 112 over regions of the current collector 112 corresponding to tabs 116 of electrode-separator assemblies fabricated on the web 160 of current collector 112.

For example, the collector masking station can apply parallel rows of adhesive-backed masking tape—of width equal to the tab 116 width of completed electrode-separator assemblies—to both sides of the web 160 of current collector 112 at pitch intervals corresponding to pitch distances between adjacent columns of electrode-separator assemblies fabricated on the web 160 of current collector 112 by the manufacturing system.

### 4.3 Electrode Material Application Station

The electrode material 114 application station is downstream of the collector masking station and includes: a coating head (e.g., a slot-die, a comma-bar coating head); a reservoir containing a slurry of electrode material 114 (e.g., anode material, cathode material); a pump configured to supply the slurry of electrode material 114 from the reservoir to the coating head; and a set of heaters.

The electrode material 114 application station is configured: to receive the web 160 of masked current collector 112 from the collector masking station; to deposit a slurry of electrode material 114 onto both sides of the web 160 of masked current collector 112; and to heat the web 160 of current collector 112 in order to dry, cure, and/or adhere the electrode material 114 to the web 160 of masked current collector 112 and thus yield a web 160 of electrode assemblies 110.

In one example, the slurry of electrode material 114 includes: a solvent (e.g., N-methyl-2-pyrrolidone (NMP, water); particulates of active material (e.g., graphite, silicon-carbon composite, lithium cobalt oxide, lithium nickel manganese cobalt oxide, lithium iron phosphate) dispersed into the solvent; and a polymer binder (e.g., polyvinylidene fluoride, styrene-butadiene rubber, carboxymethyl cellulose) miscible in the solvent and configured to bind the particulates of active material together and adhere the active material to the collector tape.

In particular, the manufacturing system can: configure a valve arranged within the electrode material 114 application station to an open position to convey the slurry of electrode material 114 (e.g., anode material, cathode material) from the first reservoir through the first pump to the coating head according to the target slurry temperature and target slurry flow rate; and deposit the slurry of electrode material 114 from the coating head onto the web 160 of current collector 112 occupying the coating zone—according to the target coating width and target coating thickness—to form a continuous layer of slurry over the web 160 of current collector 112. For example, the manufacturing system can: deposit the slurry of electrode material 114 simultaneously onto opposing faces of the web 160 of current collector 112; and control deposition of the slurry of electrode material 114 such that the slurry of electrode material 114 covers active regions of the web 160 of current collector 112 while leaving inactive regions, including designated tab 116 areas, free of slurry deposition.

The manufacturing system can then trigger the first set of heaters to heat the continuous layer of slurry on the web 160 of current collector 112 to a target temperature to evaporate the solvent from the slurry and solidify the polymer binder in order to adhere the electrode material 114 to the web 160 of current collector 112 according to the target coating thickness. Thus, the manufacturing system can: output, from the electrode material 114 application station, a web 160 of electrode assemblies 110; and subsequently convey this web 160 of electrode assemblies 110 toward the patterning station.

### 4.4 Patterning Station

The patterning station is located downstream of the electrode material 114 application station and includes a laser cutter, a punch and die, and/or a rotary cutter die, etc. The patterning station is configured to form (e.g., cut, punch, stamp) rows and columns of perforations 117—across the web 160 of electrode assemblies 110—that delineate borders of individual electrode assemblies 110 in the web 160 of electrode assemblies 110.

The patterning station can further resect and fully remove regions of the web 160 of electrode assemblies 110—and masking tape—between adjacent electrode assemblies 110 in order to define masked tabs 116 along (lateral) edges of these individual electrode assemblies 110 bounded by perforations 117 in the web 160 of electrode assemblies 110.

### 4.5 Separator Application Station

As described in U.S. patent application Ser. No. 18/744,431, the separator application station can include: a set of spray nozzles; a coating supply configured to supply separator material 122 in a liquid state (e.g., a polymer-polymer-solvent liquid mixture) from a reservoir to the spray nozzles; and a set of heaters, a washing station, and an irradiation head (e.g., an electron beam) downstream of the spray nozzles.

The set of spray nozzles are configured to spray separator material 122—including a first polymer miscible in the first solvent and a second polymer (semi-) miscible in the first solvent and miscible in the second solvent—across both sides of the web 160 of electrode assemblies 110 and into perforations 117 in the web 160 of electrode assemblies 110 as the web 160 of electrode assemblies 110 passes through the separator application station. The set of heaters then heats the web 160 of electrode assemblies 110 to evaporate the first solvent out of the applied separator material 122, and the irradiation head irradiates the separator material 122 to cause the first polymer to crosslink. The wash station—such as an immersion tank to spray applicator—located upstream or downstream of the irradiation head—rinses the separator material 122 with a second solvent, which dissolves the second polymer, thereby rendering an open-celled network of pores in the first polymer that remains over the web 160 of electrode assemblies 110, thereby forming a monolithic conformal separator coating 120 extending across both sides of the web 160 of electrode assemblies 110 and through perforations 117 in the web 160 of electrode assemblies 110 to form a web 160 of electrode-separator assemblies 130.

Therefore, the monolithic conformal separator coating 120 can include a first polymer crosslinked to form an open-celled network of pores sized to transport ions within a battery unit 100. Therefore, the monolithic conformal separator coating 120 can be formed by: spray-coating a separator mixture—including a first solvent, the first polymer miscible in the first solvent, and a second polymer (semi-) miscible in the first solvent—onto the web 160 of electrode assemblies 110 and through perforations 117 in the web 160; drying the separator mixture to evaporate the first solvent and promote phase separation of the first polymer and the second polymer; washing the conductive substrate 111 with a second solvent to dissolve the second polymer and thus render the open-celled network of pores in the first polymer; and irradiating the first polymer to crosslink the first polymer. However, the monolithic conformal separator coating 120 can be fabricated over the web 160 of electrode assemblies 110 in any other way to form the web 160 of electrode-separator assemblies 130.

However, the separator application station can form the monolithic conformal separator coating 120 in any other way, such as by: applying multiple layers of separator coating onto the web 160 of electrode assemblies 110 and drying the separator material via direct or indirect heating; and without washing the separate material and/or without irradiating the separate material to promote crosslinking.

The separator application station passes the resulting web 160 of electrode-separator assemblies 130 to the mask removal station.

### 4.6 Mask Removal Station

The mask removal station is configured to remove the masking tape from the web 160 of electrode-separator assemblies 130 in order to expose tabs 116 on each side of the web 160 of electrode-separator assemblies 130 before feeding the web 160 of electrode-separator assemblies 130 to the resection station.

Alternatively, the manufacturing system can: remove the first mask prior to perforation of the web 160 of electrode assemblies 110; and apply a second mask—such as narrower than the first mask—over the same tab 116 locations as the first mask on the web 160 of electrode assemblies 110 prior to application of the separator material 122. Thus, the manufacturing system can: perforate the web 160 of electrode assemblies 110 along edges of the electrode material 114 on each tab 116; apply separator material 122 that extends through these perforations 117, encapsulates edges of the electrode material 114 along each tab 116, and thus mechanically strengthens each tab 116. The manufacturing system can then remove the second mask from the web 160 of electrode-separator assemblies prior to entry into the resection station.

Yet alternatively, the manufacturing system can locate a stencil over a first region of web 160 of electrode assemblies 110 during application of the separator material 122 and then remove or reposition the stencil over a next region of the web 160 in preparation for applying the separator before processing (e.g., heating, washing, irradiating) the first region of the web 160. The stencil can define apertures over faces of electrode assemblies 110, but block application of separator material 122 onto tabs 116. However, the manufacturing system can implement any other method or technique to mask or otherwise shield tabs 116 of electrode assemblies 110 in the web 160 from separator material 122. (The manufacturing system can implement similar methods and techniques to shield these tabs 116 from application of electrode material 114.)

### 4.7 Resection Station

The resection station: includes a cutting head (e.g., a laser cutter, a waterjet, a rotary slitter, a flying knife); and is configured to cut (or “dice”) the web 160 of electrode-separator assemblies—along lateral and longitudinal rows of perforations 118, 119—to form discrete electrode-separator assemblies (e.g., anode-separator assemblies, cathode-separator assemblies).

### 4.8 Battery Assembly Station

The stacking station is configured to: receive discrete electrode-separator assemblies; to assemble a stack of alternating anode-separator assemblies and cathode (or cathode-separator) assemblies; to load this stack of electrode-separator assemblies into a battery housing 102; and to electrically couple tabs 116 within the stack to corresponding battery terminals on the battery housing 102.

### 4.9 Injection Station

The injection station includes: an injection nozzle; a reservoir containing an electrolyte 150; and a pump configured to supply electrolyte 150 from the reservoir to the injection nozzle. The injection station is configured to inject electrolyte 150 into the cavity of the battery housing 102. This electrolyte 150 can then wet the monolithic conformal separator coating 120 and wick into electrode material 114 in the electrode-separator assemblies via exposed edges of electrode material 114 along distal resected regions 134 of the electrode-separator assemblies.

In one implementation, the injection station can inject a volume of electrolyte 150 into the battery housing 102 to initiate propagation and uptake of the electrolyte 150 through the uncoated resected faces of the electrode material 114 along serrated edges of the electrode-separator assemblies in order to uniformly wet the stack of electrode-separator assemblies.

The manufacturing system can then close and seal the battery housing 102 to encapsulate the electrolyte 150 and the stack of electrode-separator assemblies, thereby completing the battery unit 100.

### 5. Processing Stages

Therefore, the continuous web 160 of current collector 112 can be processed through a series of stages to form: a continuous web 160 of electrode assemblies 110; then a continuous web 160 of electrode-separator assemblies 130; then a set of discrete (i.e., individualized) electrode-separator assemblies 130, each including an electrode assembly 110 (e.g., current collector 112 coated with active electrode material 114) and a separator; and finally a complete battery unit 100 containing a set of interleaved electrode-separator assemblies 130.

### 5.1 Web of Current Collector

As shown in FIGS. 4A and 4B, the web 160 of current collector 112 can include a roll of current collector 112—such as an oxygen-free copper film—of width approximating a multiple (e.g., 2×, 10×, 100×) of the width of a completed electrode-separator assembly 130. The web 160 of current collector 112 can therefore be processed by the manufacturing system to fabricate multiple (e.g., 2, 10, 100) rows of electrode-separator assemblies 130 concurrently.

(Alternatively, the web 160 of current collector 112 can include a strip of current collector 112 of width approximating a width of a completed electrode-separator assembly 130.)

### 5.1.1 Web of Electrode Assemblies and Electrode-separator Assemblies

In particular, the web 160 of electrode-separator assemblies 130 can include: a continuous web 160 of conductive substrate 111 (e.g., current collector 112) coated with electrode material 114; and a monolithic conformal separator coating 120 extending continuously over the web 160 of conductive substrate 111.

The web 160 of electrode-separator assemblies 130 can include: a first face 141 and a second face 142 opposite the first face 141; a first series of lateral rows of perforations 118 longitudinally offset by an electrode length; and a second series of longitudinal rows of perforations 119 laterally offset by an electrode width. (More specifically, the first series of lateral rows of perforations 118 can extend perpendicular to a direction of travel of the web 160 of current collector 112 through the manufacturing system; and the second series of longitudinal rows of perforations 119 can extend parallel to the direction of travel of the web 160 of current collector 112 through the manufacturing system.)

The monolithic conformal separator coating 120 extends continuously: across the first and second faces 141, 142 of the web 160 of electrode-separator assemblies 130; and through these perforations 117.

### 5.1.2 Monolithic Conformal Separator Coating

Generally, the monolithic conformal separator coating 120 can include: a first volume 123 of a separator material 122 extending across the first face 141 of the continuous web 160 of conductive substrate 111; a second volume 124 of the separator material 122 extending across the second face 142 of the continuous web 160 of conductive substrate 111; and a third volume 125 of the separator material 122. The third volume 125 of the separator material 122 can: extend through the series of lateral rows of perforations 118 in the conductive substrate 111; form bridges between the first volume 123 of the separator material 122 and the second volume 124 of the separator material 122; and resist separation of the first volume 123 of the separator material 122 from the first face 141 and the second volume 124 of the separator material 122 from the second face 142.

Therefore, the monolithic conformal separator coating 120 can extend continuously: across the first face 141 and the second face 142 of the conductive substrate 111; and through the series of lateral rows of perforations 118 and the second series of longitudinal rows of perforations 119 in the continuous web 160 of conductive substrate 111. The conductive substrate 111 and the monolithic conformal separator coating 120 thus cooperate to form a continuous web 160 of electrode-separator assemblies 130 configured for: resection along the series of lateral rows of perforations 118 and along the second series of longitudinal rows of perforations 119 to segment the continuous electrode-separator web 160 into a set of discrete electrode-separator assemblies 130.

However, the monolithic conformal separator coating 120 may: exhibit greater internal cohesivity than adhesivity to the electrode material 114 or the current collector 112 of the conductive substrate 111; or otherwise lose adhesivity to the electrode material 114 or the current collector 112 over time. The monolithic conformal separator coating 120 may therefore separate (or “delaminate”) from the first and second faces 141, 142 of the continuous web 160 of conductive substrate 111 during processing. However, the internal cohesivity of the monolithic conformal separator coating 120—which extends through perforations 117 in the continuous web 160—may mechanically constrain regions of the monolithic conformal separator coating 120 over the first and second faces 141, 142 of the conductive substrate 111, thereby: preventing the monolithic conformal separator coating 120 from peeling back and separating from the continuous web 160; and maintaining encapsulation of the conductive substrate 111 by the monolithic conformal separator coating 120 during processing.

### 5.1.3 Perforations and Ligaments

Furthermore, the web 160 of electrode assemblies 110 is perforated along planned edges of final electrode-separator assemblies 130—later cut from the web 160—prior to application of the separator material 122. These lateral and longitudinal rows of perforations 118, 119 thus define boundaries between discrete electrode-separator assemblies 130, and the resection station can resect the web 160 of electrode-separator assemblies 130 along these lateral and longitudinal rows of perforations 118, 119 in order to separate individual electrode-separator assemblies 130 from the web 160 while preserving bridges of separator coating 120 that extend between first and second faces 141, 142 of each electrode-separator assembly 130.

Prior to application of the separator material 122, the manufacturing system tensions the web 160 of electrode assemblies 110 along its longitudinal axis as the manufacturing system draws the web 160 through subsequent stations. Longitudinal ligaments 136 between adjacent perforations 117 in each lateral row of perforations 117 in the web 160 carry this tension longitudinally through the web 160, thereby enabling continuous, serial, roll-to-roll application of separator material 122 onto a series of electrode assemblies 110. Prior to application of the separator material 122, lateral ligaments 136 between adjacent perforations 117 in each longitudinal row of perforations 117 in the web 160 function to maintain location of adjacent rows of electrode assemblies 110, thereby enabling parallel application of the separator material 122 onto multiple rows of electrode-separator assemblies 130.

Once the web 160 of electrode assemblies 110 is coated with the separator material 122, the longitudinal and lateral ligaments 136 in the web 160 enable: continuous, serial, roll-to-roll processing of the separator material 122 into the monolithic conformal separator coating 120 across of multiple rows of electrode assemblies 110 in parallel to form the web 160 of electrode-separator assemblies 130; and subsequent continuous, serial, roll-to-roll processing of multiple rows of electrode-separator assemblies 130 in parallel to dice the web 160 of electrode-separator assemblies 130 into discrete electrode-separator assemblies 130.

Therefore, perforations 117 in the web 160 of electrode assemblies 110 can enable the separator application station to apply separator material 122 that bridges the first and second faces 141, 142 of the web 160 around planned edges of each electrode-separator assembly 130, which mechanically resists peeling or separation of the monolithic conformal separator coating 120 from the first and second faces 141, 142 of the web 160 (electrode-separator assemblies 130 subsequently resected therefrom). Longitudinal and lateral ligaments 136 between these perforations 117 maintain connections between longitudinally-and laterally-adjacent electrode assemblies 110 to enable the manufacturing system to serially process electrode assemblies 110 (and later electrode-separator assemblies 130) in multiple rows of electrode-separator assemblies 130 (and later electrode-separator assemblies 130) in parallel.

### 5.1.4 Perforation Open Areas for Web Tension+Coating Resilience

Furthermore, the longitudinal ligaments 136 carry relatively large longitudinal tensile forces through the web 160 as the manufacturing system draws the web 160 through the sequence of stations, while the lateral ligaments 136 carry relatively small lateral forces that maintain lateral positions of rows of electrode assemblies 110 (and later electrode-separator assemblies 130) in the web 160. Therefore, because longitudinal tensile forces through the web 160 may be (considerably) greater than lateral forces through the web 160, the total cross-sectional area of a row of longitudinal ligaments 136 extending across one end of an electrode assembly 110 (or across the entire width of the web 160) can be greater than the total cross-sectional area of a column of lateral ligaments 136 extending across one side of the electrode assembly 110.

For example and as shown in FIGS. 1, 4A, and 4B, the web 160 can include a greater count of and/or wider longitudinal ligaments 136 and fewer and/or narrower lateral ligaments 136 between lateral and longitudinal rows of perforations 118, 119, respectively. Accordingly, the web 160 can include fewer and/or narrower perforations 117 in lateral rows of perforations 118 and/or a greater count of and/or longer perforations 117 in longitudinal rows of perforations 119. In other words, a lateral row of perforations 117—extending across the end of one electrode assembly 110 or across the entire width of the web 160—can be characterized by a first open area ratio; and a longitudinal row of perforations 117 can be characterized by a second open area ratio greater than the first open area ratio. In this example, the perforations 117 can define circular, elliptical, squircular (i.e., rectangular with radiused corners) geometries, such as: lateral rows of circular perforations 117; and longitudinal rows of squircular perforations 117.

Furthermore, because the web 160 of electrode assemblies 110 includes longitudinal rows of perforations 119 characterized by a larger open area ratio and because the manufacturing system coats these perforations 117 with separator material 122, the resulting monolithic conformal separator coating 120 can encapsulate a larger proportion of the sides of each completed electrode-separator assembly 130 and exhibit greater bulk volume and thus greater mechanical resilience along these sides of these completed electrode-separator assemblies 130, thereby: reducing risk of shorting in exposed edges of current collector 112 or electrode material 114 along sides of completed electrode-separator assemblies 130 without increased risk of bunching, tearing, or wrinkling of the web 160 during processing.

### 5.1.4.1 Perforation Dimensions

Generally, increasing the open area of a lateral row of perforations 117 bounding an edge of an electrode-separator assembly 130 within the web 160—such as by increasing a quantity of perforations 117 in the series and/or increasing a width or radius of each perforation in the series—may: decrease tensile strength of the web 160 perpendicular to the row of perforations 117; decrease a total area of uncoated resected regions of current collector 112 and electrode material 114 along this edge of the electrode-separator assembly 130 once resected from the web 160 and thus reduce shorting risk along this edge of the electrode-separator assembly 130; decrease a reaction of lithium on exposed edges of the electrode-separator assembly 130 and thus decrease the likelihood of dendrite growth on these exposed edges; decrease electrolyte 150 wetting rate into the electrode material 114; and increase a (cohesive) strength of the separator coating 120 near this edge of the electrode-separator assembly 130, both before and after resection of the electrode-separator assembly 130 from the web 160.

Conversely, decreasing the open area of the lateral row of perforations 117 bounding the edge of the electrode-separator assembly 130 within the web 160—such as by decreasing the quantity of perforations 117 in the series and/or decreasing the width or radius of each perforation in the series—may: increase tensile strength of the web 160 perpendicular to the row of perforations 117; increase the total area of uncoated resected regions of current collector 112 and electrode material 114 along this edge of the electrode-separator assembly 130 once resected from the web 160 and thus increase shorting risk along this edge of the electrode-separator assembly 130; increase electrolyte 150 wetting rate into the electrode material 114; and increase a strength of the separator coating 120 near this edge of the electrode-separator assembly 130, both before and after resection of the electrode-separator assembly 130 from the web 160.

Therefore, the manufacturing system can perforate the web 160 of electrode assemblies 110 to balance: lateral and longitudinal tensile strength of the web 160; electrolyte 150 wetting rate, and strength of the monolithic conformal separator coating 120. For example, the manufacturing system can perforate the web 160 of electrode assembly 110 according to an open area ratio—equal to a total perforation width (i.e., a perforation width multiplied by a count of perforations 117 along an edge of an electrode assembly 110) divided by a total width of the edge of the electrode assembly 110—between 0.2 and 0.8 (or 0.4 and 0.6).

In another example, the current collector 112 is between 5 microns and 20 microns in thickness. The electrode material 114 is between 40 microns and 100 microns in thickness and extends over both sides of the current collector 112. A first end 143 of the electrode-separator assembly 130 defines the first serrated geometry that includes: a series of linear segments interposed between a series of proximal resected regions 132, wherein the series of proximal resected regions 132 defines semicircular segments between 400 microns and 600 microns in radius and wherein each linear segment defines a ligament 136 between 200 microns and 400 microns in width. The separator: includes a monolithic conformal separator coating 120 between 5 microns and 20 microns in thickness on each side of the electrode assembly 110; and extends over the series of proximal resected regions 132.

### 5.1.5 Tabs

As described above and as shown in FIGS. 4A and 4B, the web 160 of current collector 112 can be masked during application of both the electrode material 114 and the separator material 122 in order to form regions of exposed current collector 112—across the web 160—at planned locations of tabs 116 on each completed electrode-separator assembly 130. The patterning station can cut (or “trim”) the web 160 of electrode assemblies 110 to remove regions of current collector 112 ahead of and/or behind each tab 116 in order to form tab-side edges of electrode assemblies 110 that are inset from their corresponding tabs 116. When the separator application station then applies separator material 122 to the web 160 of electrode assemblies 110, the separator material 122 can flow around these tab-side edges to form elongated bridges between monolithic conformal separator coatings 120 on each face of the web 160 of electrode assembly 110.

In one implementation, the web 160 of electrode assemblies 110 includes rows of electrode assemblies 110: separated by rows of perforations 117; and thus connected by longitudinal ligaments 136. The tab 116 of each electrode assembly 110 in the row extends laterally. Each row of electrode assemblies 110 in the web 160 defines mirrored (or “butterflied”) pairs of adjacent electrode assemblies 110, wherein: a first tab 116 of a first electrode assembly 110 is connected to and is continuous with a second tab 116 of a second, adjacent electrode assembly 110 and carries lateral forces between the first and second electrode assemblies 110; a second side 146 of the second electrode assembly 110—opposite the second tab 116—is connected to a third side of a third, adjacent electrode assembly 110 via a column of lateral ligaments 136 that carry lateral forces between the second and third electrode assemblies 110; and a third tab 116 of the third electrode assembly 110—opposite the third side—is connected to and is continuous with a fourth tab 116 of a fourth, adjacent electrode assembly 110 and carries lateral forces between the third and fourth electrode assembly 110; etc.

Therefore, the web 160 of electrode assemblies 110 can define a single tab 116—extending laterally across the web 160—per electrode assembly 110. Conversely, the web 160 of electrode assembly 110 can define multiple tabs 116 per electrode assembly 110, such as extending laterally from a single side or from both sides of the electrode assembly 110. The tab 116(s) of one electrode assembly 110 can be connected—continuously via the current collector 112—to the tab 116(s) of an adjacent electrode assembly 110 to laterally locate these adjacent electrode assemblies 110 within the web 160. However, the web 160 of electrode assembly 110 and the web 160 of electrode-separator assemblies 130 can define any other count, geometry, or connection between tabs 116 of electrode assemblies 110 and electrode-separator assemblies 130.

### 5.1.5.1 Tab Masking and Processing

Once the web 160 of current collector 112 is masked over tab regions (e.g., with continuous longitudinal strips of masking tape), and coated with electrode material 114, the web 160 of electrode assemblies 110 can be: unmasked (e.g., by removing the masking tape); perforated to form the lateral and longitudinal series of perforations 117; and trimmed to remove current collector 112 (and excess electrode material 114) ahead or behind each tab 116. The web 160 of electrode assembly 110 can then be re-masked over the tab regions (e.g., with a second set of continuous longitudinal strips of masking tape) before application of the separator material 122 onto both faces of the web 160 of electrode assembly 110. Once the separator material 122 is processed to form the monolithic conformal separator coating 120, the resulting electrode-separator assembly 130 can be unmasked (e.g., by removing the masking tape).

Alternatively, the web 160 of current collector 112 can be masked once (e.g., with continuous longitudinal strips of masking tape), coated with electrode material 114, perforated, and coated with the separator material 122. The single masking can then be removed before or after processing of the separator material 122 to form the monolithic conformal separator coating 120 and before the web 160 of electrode-separator assemblies 130 is cut to form discrete electrode-separator assemblies 130.

### 5.1.5.2 Tab Perforations

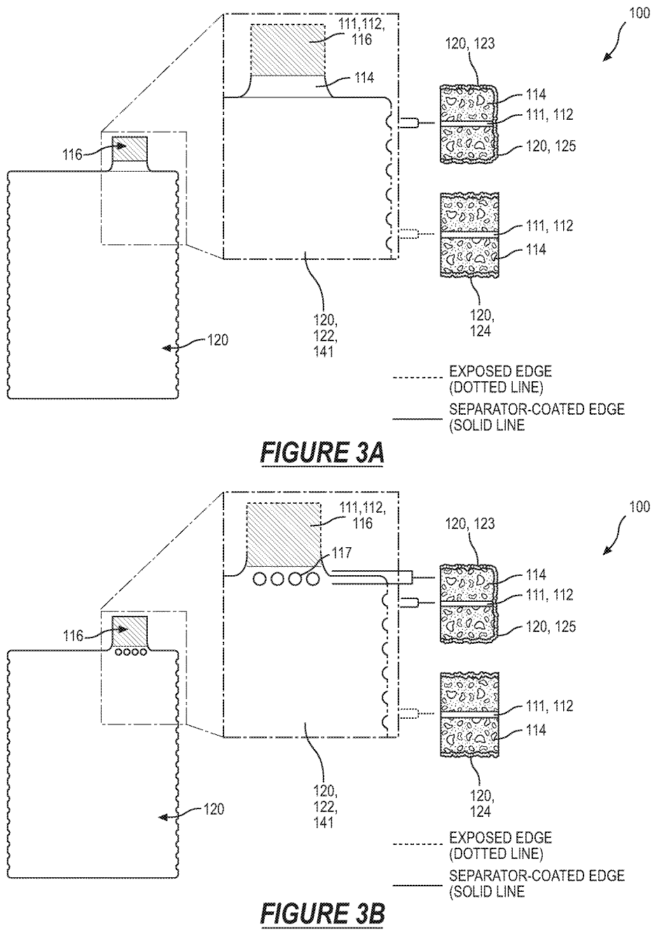

In one implementation shown in FIG. 3B, the patterning station further perforates the web 160 of electrode assemblies 110 along or near an interface between an edge of the electrode material 114 and the exposed current collector 112 at each tab 116. The separator application station then applies separator material 122 to the web 160 of electrode assembly 110, which flows through these tab perforations 117. Once the separator material 122 is processed, the resulting monolithic conformal separator coating 120 includes volumes that: coat and extend through these tab perforations 117; (encapsulate the edge of the electrode material 114;) mechanically resist peeling or separation of the monolithic conformal separator coating 120 from the electrode assemblies 110 near these tabs 116; and/or mechanically support these tabs 116, thereby resisting damage to the tab 116 when bent, folded, or otherwise manipulated during assembly of a battery unit 100 with completed electrode-separator assemblies 130.

(Additionally or alternatively, the web 160 of electrode-separator assemblies 130 can include tabs 116 that extend longitudinally between adjacent electrode-separator assemblies 130 rather than laterally. Thus, longitudinal tension within the web 160—resulting from advancement of the web 160 through the manufacturing system—can be carried through these tabs 116 rather than or in addition to longitudinal ligaments 136 between lateral rows of perforations 118.)

### 5.1.6 Continuous Web of Electrode-separator Assemblies

As shown in FIG. 4B, the resulting continuous web 160 of electrode-separator assemblies 130 can thus be configured for resection along lateral and longitudinal rows of perforations 118, 119—and between interconnected tabs 116 of adjacent electrode-separator assemblies 130—in order to segment the continuous web 160 of electrode-separator assemblies 130 into a set of discrete electrode-separator assemblies 130 that can later be stacked with complementary (e.g., cathode) electrode assemblies to form a battery unit 100. The web 160 of electrode-separator assemblies 130 can be cut directly into discrete electrode-separator assemblies 130 following exit from the separator application station or the mask removal station. Alternatively, the web 160 of electrode-separator assemblies 130 can be wound back onto a reel, stored, and/or moved before later being cut into discrete electrode-separator assemblies 130.

### 5.2 Individual Electrode-separator Assemblies

As described above, the web 160 of electrode-separator assemblies 130 can be resected (e.g., “cut,” “diced”) along lateral series of perforations 117, longitudinal series of perforations 117, and/or between interconnected tabs 116 of adjacent electrode-separator assemblies 130 in order to form discrete (i.e., individualized) electrode-separator assemblies 130, as shown in FIG. 1. For example, the resection station can include a set of laser cutters configured to cut the web 160 of electrode-separator assemblies 130 laterally and longitudinally along these perforations 117—as the web 160 passes continuously through the resection station—in order to separate individual, completed electrode-separator assemblies 130 from the web 160.

Each electrode-separator assembly 130 includes: an electrode assembly 110; and a separator.

The electrode assembly 110 includes a conductive substrate 111 (e.g., a current collector 112) coated with electrode material 114 and defines: a first face 141; a second face 142 opposite the first face 141; a first end 143 defining a first serrated geometry; a second end 144 opposite the first end 143 and defining a second serrated geometry; a first side 145 extending (longitudinally) between the first end 143 and the second end 144; and a second side 146 opposite the first side 145.

The separator includes (or “forms”) a monolithic conformal separator coating 120 and extends continuously: across the first face 141 and the second face 142 of the first electrode assembly 110; around the first side 145 and the second side 146 of the first electrode assembly 110; and around proximal resected regions 132 on the first end 143 and the second end 144 of the first electrode assembly 110.

### 5.2.1 Monolithic Conformal Separator Coating

As described above, the monolithic conformal separator coating 120 may: exhibit greater internal cohesivity than adhesivity to the electrode material 114 or the current collector 112 of the conductive substrate 111; and/or may lose adhesive (e.g., physical and/or chemical) bond strength to the electrode material 114 over time, such as due to thermal cycling of a battery unit 100 containing the electrode-separator assembly 130 or due to electrolyte 150 wetting of the electrode material 114 or separator. The monolithic conformal separator coating 120 may therefore separate (or “delaminate”) from the electrode assembly 110, such as during production or use of the battery unit 100. However, the monolithic conformal separator coating 120 can encapsulate the entire electrode assembly 110—outside of the tab 116 and resected ligament 136 regions of the electrode assembly 110. Given its internal cohesivity, regions of the monolithic conformal separator coating 120 that extend around edges of the electrode-separator assembly 130 and/or through perforations 117 in the tab 116 may thus mechanically constrain and prevent the monolithic conformal separator coating 120 from separating (or “curling,” “peeling back”) from the electrode assembly 110.

More specifically, because the web 160 of electrode-separator assemblies 130 is resected (or “cut,” “diced”) through (e.g., approximately centered along) separator-coated perforations 117, a discrete electrode-separator assembly 130 cut from the web 160 of electrode-separator assemblies 130 includes monolithic conformal separator coating 120 that extends around resected edges of the electrode-separator assembly 130 and through perforations 117 along the tab 116, which mechanically constrains larger regions of monolithic conformal separator coating 120 located over broad faces of the electrode assembly 110, thereby preventing these regions of monolithic conformal separator coating 120 from separating (or “curling,” “peeling back”) from the underlying electrode material 114 and/or the current collector 112.

Furthermore, the monolithic conformal separator coating 120 can include a heterogenous or homogenous, single-layer or multi-layer coating that encapsulates the web 160 of electrode assemblies 110. For example, multiple layers of separator material can be applied and processed over the web 160 of electrode assemblies 110 to form a monolithic, heterogenous, multilayer conformal separator coating 120 that encapsulates the web 160 of electrode assemblies 110.

### 5.2.2 Serrated Edges+Exposed Current Collector

As described above, the electrode assembly 110 and the separator of an electrode-separator assembly 130 are formed by: forming a lateral row of perforations 117 in the conductive substrate 111; applying the monolithic conformal separator coating 120 across the conductive substrate 111 and through the lateral row of perforations 117; and resecting the conductive substrate 111 and the monolithic conformal separator coating 120—following application of the monolithic conformal separator coating 120 onto the conductive substrate 111—along (e.g., centered through) the lateral row of perforations 117 to form a first serrated geometry along the first end 143 of the electrode-separator assembly 130.

Accordingly and as shown in FIG. 1, the separator can include: a first volume 123 of the monolithic conformal separator coating 120 extending across the first face 141 of the electrode-separator assembly 130; a second volume 124 of the monolithic conformal separator coating 120 extending across the second face 142 of the electrode-separator assembly 130; and a third volume 125 of the monolithic conformal separator coating 120. The third volume 125 of the monolithic conformal separator coating 120: extends around a first set of proximal resected regions 132 on the first end 143 of the conductive substrate 111 corresponding to the lateral row of perforations 117; and is configured to resist separation of the first volume 123 of the monolithic conformal separator coating 120 from the first face 141 and the second volume 124 of the monolithic conformal separator coating 120 from the second face 142 proximal the first end 143 of the electrode-separator assembly 130. However, because the electrode-separator assembly 130 is resected along perforations 117 after application of the separator material 122, the monolithic conformal separator coating 120 is excluded from distal resected regions 134 on the first end 143 of the conductive substrate 111 that correspond to ligaments 136 between perforations 117 in the web 160 of electrode-separator assemblies 130 from which the electrode-separator assembly 130 was cut.

The second, opposing end of the electrode-separator assembly 130 can be similarly formed and can define a similar first serrated geometry. The monolithic conformal separator coating 120 can similarly extend across this second end 144 of the electrode-separator assembly 130.

The first side 145 of the electrode-separator assembly 130—perpendicular to the first and second ends 143, 144—can also define a second serrated geometry. In particular, the electrode-separator assembly 130 can be further formed by: forming a longitudinal row of perforations 117 orthogonal to and extending up to the lateral row of perforations 117 in the conductive substrate 111; applying the monolithic conformal separator coating 120 through the longitudinal row of perforations 117; and resecting the conductive substrate 111 and the monolithic conformal separator coating 120—following application of the monolithic conformal separator coating 120 onto the conductive substrate 111—a) along the lateral row of perforations 117 to separate the electrode-separator assembly 130 from a second electrode longitudinally offset from the electrode-separator assembly 130 and b) along the longitudinal row of perforations 117 to form the second serrated geometry along the first side 145 of the electrode-separator assembly 130 and to separate the electrode-separator assembly 130 from a third electrode-separator assembly 130 laterally offset from the electrode-separator assembly 130. Thus, the separator can further include a fourth volume of the monolithic conformal separator coating 120 that: extends around a second set of proximal resected regions 132 on the first side 145 of the conductive substrate 111 corresponding to the longitudinal row of perforations 117; and is configured to resist separation of the first volume 123 of the monolithic conformal separator coating 120 from the first face 141 and the second volume 124 of the monolithic conformal separator coating 120 from the second face 142 proximal the first side 145 of the electrode assembly 110. Like the third volume 125 of the monolithic conformal separator coating 120, this fourth volume of the monolithic conformal separator coating 120 is excluded from a second set of distal resected regions 134 on the first side 145 of the conductive substrate 111 that correspond to ligaments 136 between perforations 117 in the web 160 of electrode-separator assemblies 130 from which the electrode-separator assembly 130 was cut.

Therefore, regions along the edges of that discrete electrode-separator assembly 130—that previously corresponded to ligaments 136 that connected the perimeter of the electrode-separator assembly 130 to adjacent electrode-separator assemblies 130 in the web 160—may include exposed ends of current collector 112 and electrode material 114. However, the monolithic conformal separator coating 120: encircles these exposed current collector 112 and electrode material 114 ends; and functions as a physical buffer or barrier between these current collector 112 and electrode material 114 ends and conductive material in adjacent complementary electrodes (e.g., cathode assembles) and/or a conductive housing of a battery unit 100 in which the electrode-separator assembly 130 is installed.

### 5.2.3 Tabs

As described above, an electrode assembly 110 can also include a conductive tab 116 that extends laterally from a side of the electrode-separator assembly 130; and the separator can be excluded from the conductive tab 116 in order to enable the electrode-separator assembly 130 to be electrically coupled: to a terminal of the battery unit 100 in which the electrode-separator assembly 130 is installed; and/or to an adjacent electrode-separator assembly 130 within the battery unit 100.

As described above, the electrode assembly 110 can be perforated to form a set of perforations 117 interposed between the tab 116 and an adjacent side of the electrode assembly 110; and the monolithic conformal separator coating 120 can extend through this set of perforations 117. The electrode assembly 110 and the separator can thus be formed by: forming a set of perforations 117 in the conductive substrate 111 between the tab 116 and the second side 146 of the electrode assembly 110; and applying the monolithic conformal separator coating 120 a) across the conductive substrate 111 and b) through the set of perforations 117. The separator can therefore include: a first volume 123 of the monolithic conformal separator coating 120 extending across the first face 141 of the electrode assembly 110; a second volume 124 of the monolithic conformal separator coating 120 extending across the second face 142 of the electrode assembly 110; and a third volume 125 of the monolithic conformal separator coating 120 a) extending through the set of perforations 117, b) forming bridges between the first volume 123 of the monolithic conformal separator coating 120 and the second volume 124 of the monolithic conformal separator coating 120, c) configured to resist separation of the first volume 123 of the monolithic conformal separator coating 120 from the first face 141 and the second volume 124 of the monolithic conformal separator coating 120 from the second face 142 between the second side 146 and the first tab 116, and d) configured to mechanically support the tab 116.

### 5.2.4 Discrete Electrode-separator Assemblies

Therefore, and as shown in FIG. 1, the continuous web 160 of electrode-separator assemblies 130 can be cut along rows and columns of perforations 117 and/or between interconnected tabs 116 of adjacent electrode-separator assembly 130 in order to form discrete electrode-separator assemblies 130. Each electrode-separator assembly 130 thus includes: an electrode assembly 110 containing current collector 112 coated with electrode material 114; ends exhibiting serrated geometries resulting from resection along lateral rows of perforations 118 between longitudinally-adjacent electrode-separator assemblies 130; a first side 145 exhibiting a serrated geometry resulting from resection along a longitudinal row of perforations 117 between laterally-adjacent electrode-separator assemblies 130; a tab 116 extending from a second side 146 of the electrode-separator assembly 130; and a monolithic conformal separator coating 120. The monolithic conformal separator coating 120 encapsulates: the front and rear faces of the electrode assembly 110; the second side 146 of the electrode assembly 110 adjacent the tab 116; and/or concave proximal resected regions 132 on the first end 143, the second end 144, and the first side of the electrode assembly 110.

### 5.3 Battery Unit

As shown in FIGS. 2 and 4B, multiple individual electrode-separator assemblies 130 (e.g., anode-separator assemblies) and complementary electrode assemblies 110 or electrode-separator assemblies 130 (e.g., cathode assemblies or cathode-separator assemblies) can be interleaved, electrically coupled via their tabs 116, and stacked to form a battery cell. A rectilinear stack of electrode-separator assemblies 130 can then be loaded into a rectilinear or cylindrical battery housing 102, such as to form a prismatic, pouch, coin, or button battery unit 100. Alternatively, the stack of electrode-separator assemblies 130 can be rolled into a cylindrical form and loaded into a cylindrical battery housing to form a cylindrical battery unit 100.

For example, a first anode-separator assembly and a second anode-separator assembly: can both be resected from a web 160 of anode-separator assemblies; and can both define planar anodes. In this example, a first cathode assembly and a second cathode assembly: can include current collectors 112 coated with bare cathode material; can both be resected from a similar web 160 of cathode assemblies (excluding separator material 122); and can both define planar cathodes. Accordingly, the first planar cathode, the first planar anode, the second planar cathode, and the second planar anode can be stacked to form a rectilinear battery cell.

In another example, a first anode-separator assembly and a second anode-separator assembly: can both be resected from a web 160 of anode-separator assemblies; and can both define flat anodes. A first cathode-separator assembly and a second cathode-separator assembly: can be similarly resected from a web 160 of cathode-separator assemblies; and can both define flat cathodes. The first flat anode, the first flat cathode, the second flat anode, and the second flat cathode can be stacked and rolled to form a cylindrical battery cell.

Therefore, individual electrode-separator assemblies 130 can be stacked to form a battery cell that can be loaded into a battery housing 102 to form a battery unit 100.

### 5.3.1 Electrolyte

As described above and as shown in shown in FIG. 4B, the serrated edges of an electrode-separator assembly 130 include both: separator-coated proximal resected faces (i.e., separator-coated concave proximal faces near the center of the electrode-separator assembly 130); and distal resected faces (i.e., furthest from the center of the electrode-separator assembly 130) that correspond to prior ligaments 136 connecting the electrode-separator assembly 130 to adjacent electrode-separator assemblies 130 and on which small regions of the current collector 112 and the electrode material 114 are exposed due to resection of the web 160 of electrode-separator assemblies 130 through these ligaments 136.

Once the electrode-separator assembly 130 is loaded into a battery housing 102, electrolyte 150 can be injected (or “dosed”) into the battery housing 102 (e.g., by flooding the battery housing 102 with electrolyte 150). The electrolyte 150 can then permeate laterally (or “wick”) into the electrode material 114—located between the current collector 112 and the monolithic conformal separator coating 120—via these small regions of exposed electrode material 114. Therefore, the uncoated resected distal faces of the electrode material 114 along the serrated edges of the electrode-separator assembly 130 can accelerate electrolyte 150 ingress into the electrode material 114—which is otherwise encapsulated by the monolithic conformal separator coating 120—which may reduce wetting time of the electrode material 114, support faster takt time during battery production, and enable (more) complete wetting of the electrode material 114, which may improve performance of the battery unit 100.

(Additionally or alternatively, the electrolyte 150 can permeate vertically into the monolithic conformal separator coating 120 and then vertically into electrode material 114.)

### 6. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a first electrode assembly:
comprising a conductive substrate; and
comprising:
a first face;
a second face opposite the first face;
a first end defining a first serrated geometry;
a second end opposite the first end and defining a second serrated geometry;
a first side extending between the first end and the second end; and
a second side opposite the first side; and
a first separator:
comprising a monolithic conformal separator coating; and
extending continuously:
across the first face and the second face of the first electrode assembly;
around the first side and the second side of the first electrode assembly; and
around proximal resected regions on the first end and the second end of the first electrode assembly.

2. The system of claim 1:
wherein the first electrode assembly and the first separator are formed by:
forming a lateral row of perforations in the conductive substrate;
applying the monolithic conformal separator coating:
across the conductive substrate; and
through the lateral row of perforations; and
resecting the conductive substrate and the monolithic conformal separator coating, following application of the monolithic conformal separator coating over the conductive substrate:
along the lateral row of perforations to form the first serrated geometry along the first end of the first electrode assembly; and
wherein the first separator:
comprises a first volume of the monolithic conformal separator coating extending across the first face of the first electrode assembly;
comprises a second volume of the monolithic conformal separator coating extending across the second face of the first electrode assembly;
comprises a third volume of the monolithic conformal separator coating:
extending around a first set of proximal resected regions on the first end of the conductive substrate corresponding to the lateral row of perforations; and
configured to resist separation of the first volume of the monolithic conformal separator coating from the first face and the second volume of the monolithic conformal separator coating from the second face proximal the first end of the first electrode assembly; and
is excluded from a first set of distal resected regions on the first end of the conductive substrate corresponding to areas of the conductive substrate between the lateral row of perforations.

3. The system of claim 1:
wherein the first side of the first electrode assembly defines a third serrated geometry;
wherein the first electrode assembly and the first separator are further formed by:
forming a longitudinal row of perforations orthogonal to and extending up to the lateral row of perforations in the conductive substrate;
applying the monolithic conformal separator coating through the longitudinal row of perforations; and
resecting the conductive substrate and the monolithic conformal separator coating, following application of the monolithic conformal separator coating over the conductive substrate:
along the lateral row of perforations to separate the first electrode assembly from a second electrode longitudinally offset from the first electrode assembly; and
along the longitudinal row of perforations to:
form the third serrated geometry along the first side of the first electrode assembly; and
separate the first electrode assembly from a third electrode assembly laterally offset from the first electrode assembly on the conductive substrate; and
wherein the first separator:
further comprises a fourth volume of the monolithic conformal separator coating:
extending around a second set of proximal resected regions on the first side of the conductive substrate corresponding to the longitudinal row of perforations; and
configured to resist separation of the first volume of the monolithic conformal separator coating from the first face and the second volume of the monolithic conformal separator coating from the second face proximal the first side of the first electrode assembly; and
is excluded from a second set of distal resected regions on the first side of the conductive substrate between the longitudinal row of perforations.

4. The system of claim 3, wherein the first electrode assembly and the first separator are formed by perforating the conductive substrate to form:
the lateral row of perforations characterized by a first open area ratio; and
the longitudinal row of perforations characterized by a second open area ratio greater than the first open area ratio.

5. The system of claim 1:
further comprising:
a second electrode:
comprising the conductive substrate; and
comprising:
a third face;
a fourth face;
a third end resected along a first set of perforations between the second end of the first electrode assembly and the second electrode to:
separate the first electrode assembly from the second electrode; and
form a third serrated geometry;
a fourth end opposite the third end;
a third side extending between the third end and the fourth end; and
a fourth side opposite the third side; and
a second separator:
comprising the monolithic conformal separator coating applied to the first electrode assembly and the second electrode prior to resection along the first set of perforations; and
extending continuously:
across the third face and the fourth face of the second electrode;
around the third side and the fourth side of the second electrode; and
around proximal resected regions on the third end and the fourth end of the second electrode; and
excluded from distal resected regions on the third end of the second electrode resulting from resection of the monolithic conformal separator coating along the first set of perforations; and
wherein the first separator is excluded from distal resected regions on the second end of the first electrode assembly resulting from resection of the monolithic conformal separator coating along the first set of perforations.

6. The system of claim 5:
wherein the first electrode assembly defines a first planar anode;
wherein the second electrode defines a second planar anode;
further comprising:
a first planar cathode; and
a second planar cathode; and
wherein the first planar cathode, the first planar anode, the second planar cathode, and the second planar anode are stacked to form a rectilinear battery cell.

7. The system of claim 5:
wherein the first electrode assembly defines a first flat cathode;
wherein the second electrode defines a second flat cathode;
further comprising:
a first flat anode; and
a second flat anode; and
wherein the first flat anode, the first flat cathode, the second flat anode, and the second flat cathode are stacked and rolled to form a cylindrical battery cell.

8. The system of claim 1:
wherein the first electrode assembly and the first separator are formed by:
forming a first set of perforations in the conductive substrate;
forming a second set of perforations, longitudinally offset from the first set of perforations by a length of the first electrode assembly, in the conductive substrate;
applying the monolithic conformal separator coating:
continuously across the conductive substrate; and
through the first set of perforations and the second set of perforations; and
resecting the conductive substrate and the monolithic conformal separator coating, following application of the monolithic conformal separator coating over the conductive substrate:
along the first set of perforations to form the first serrated geometry along the first end of the first electrode assembly; and
along the second set of perforations to form the second serrated geometry along the second end of the first electrode assembly; and
wherein the first separator is excluded from:
distal resected regions on the first end of the first electrode assembly resulting from resection of the monolithic conformal separator coating along the first set of perforations; and
distal resected regions on the second end of the first electrode assembly resulting from resection of the monolithic conformal separator coating along the second set of perforations.

9. The system of claim 1:
wherein the first electrode assembly and the first separator are formed by:
forming a first set of perforations in the conductive substrate;
forming a second set of perforations, longitudinally offset from the first set of perforations by a length of the first electrode assembly, in the conductive substrate;
applying the monolithic conformal separator coating:
across the conductive substrate; and
through the first set of perforations and the second set of perforations; and
resecting the conductive substrate and the monolithic conformal separator coating, following application of the monolithic conformal separator coating over the conductive substrate:
along the first set of perforations to form the first serrated geometry along the first end of the first electrode assembly; and
along the second set of perforations to form the second serrated geometry along the second end of the first electrode assembly; and
wherein the first separator:
comprises a first volume of the monolithic conformal separator coating extending across the first face of the first electrode assembly;
comprises a second volume of the monolithic conformal separator coating extending across the second face of the first electrode assembly;
comprises a third volume of the monolithic conformal separator coating:
extending around regions on the first end of the conductive substrate corresponding to the first set of perforations; and
configured to resist separation of the first volume of the monolithic conformal separator coating from the first face and the second volume of the monolithic conformal separator coating from the second face proximal the first end of the first electrode assembly; and
comprises a fourth volume of the monolithic conformal separator coating:
extending around regions on the second end of the conductive substrate corresponding to the second set of perforations; and
configured to resist separation of the first volume of the monolithic conformal separator coating from the first face and the second volume of the monolithic conformal separator coating from the second face proximal the second end of the first electrode assembly.

10. The system of claim 1:
wherein the first electrode assembly further defines a first conductive tab extending laterally from the second side opposite the first side; and
wherein the first separator is excluded from the first conductive tab.

11. The system of claim 10:
wherein the first electrode assembly is perforated to form a set of perforations interposed between the tab and the second side of the first electrode assembly;
wherein the monolithic conformal separator coating is applied through the set of perforations;
wherein the first electrode assembly and the first separator are formed by:
forming a set of perforations in the conductive substrate between the tab and the second side of the first electrode assembly; and
applying the monolithic conformal separator coating:
across the conductive substrate; and
through the set of perforations; and
wherein the first separator:
comprises a first volume of the monolithic conformal separator coating extending across the first face of the first electrode assembly;
comprises a second volume of the monolithic conformal separator coating extending across the second face of the first electrode assembly; and
comprises a third volume of the monolithic conformal separator coating:
extending through the set of perforations;
forming bridges between the first volume of the monolithic conformal separator coating and the second volume of the monolithic conformal separator coating;
configured to resist separation of the first volume of the monolithic conformal separator coating from the first face and the second volume of the monolithic conformal separator coating from the second face between the second side and the first tab; and
configured to mechanically support the tab.

12. The system of claim 1:
wherein the first separator:
comprises a first polymer crosslinked to form an open-celled network of pores sized to transport ions; and
is formed by:
spray-coating a separator mixture onto the conductive substrate and through a set of perforations in the conductive substrate, the separator mixture comprising:
a first solvent;
the first polymer miscible in the first solvent; and
a second polymer miscible in the first solvent;
drying the separator mixture to:
evaporate the first solvent; and
promote phase separation of the first polymer and the second polymer; and
washing the conductive substrate with a second solvent to:
dissolve the second polymer; and
render the open-celled network of pores in the first polymer; and
wherein the conductive substrate is resected along the set of perforations to form the first serrated geometry of the first end of the first electrode assembly.

13. The system of claim 1:
wherein the first electrode assembly comprises:
a current collector between 5 microns and 20 microns in thickness; and
an active electrode material between 40 microns and 100 microns in thickness on each face of the current collector;
wherein the first end of the first electrode assembly defines the first serrated geometry comprising:
a series of linear segments interposed between a series of proximal resected regions, the series of proximal resected regions defining semicircular segments between 400 microns and 600 microns in radius; and
wherein the first separator:
comprises the monolithic conformal separator coating between 5 microns and 20 microns in thickness on each face of the first electrode assembly; and
extends over the series of proximal resected regions.

14. A system comprising:
a conductive substrate:
comprising a continuous web defining:
a first face; and
a second face opposite the first face; and
comprising a series of lateral rows of perforations longitudinally offset by an electrode length; and
a monolithic conformal separator coating extending continuously:
between the first face and the second face of the conductive substrate; and
through the series of lateral rows of perforations.

15. The system of claim 14, wherein the monolithic conformal separator coating comprises:
a first volume of a separator material extending across the first face of the continuous web of the conductive substrate;
a second volume of the separator material extending across the second face of the continuous web of the conductive substrate; and
a third volume of the separator material:
extending through the series of lateral rows of perforations in the conductive substrate;
forming bridges between the first volume of the separator material and the second volume of the separator material; and
configured to resist separation of the first volume of the separator material from the first face and the second volume of the separator material from the second face.

16. The system of claim 14, wherein the conductive substrate and the monolithic conformal separator coating cooperate to form a continuous electrode-separator web configured for:
resection along the series of lateral rows of perforations to segment the continuous electrode-separator web into a set of electrode-separator assemblies, each electrode-separator assembly in the set of electrode-separator assemblies comprising:
an electrode assembly:
comprising a segment of the conductive substrate; and
comprising:
a first electrode face;
a second electrode face opposite the first electrode face;
a first end defining a first serrated geometry;
a second end opposite the first end defining a second serrated geometry;
a first side extending between the first end and the second end; and
a second side opposite the first side; and
a separator:
comprising a segment of the monolithic conformal separator coating;
extending continuously:
across the first electrode face and the second electrode face of the electrode assembly;
around the first side and the second side of the electrode assembly; and
around proximal resected regions on the first end and the second end of the first electrode assembly.

17. The system of claim 14:
wherein the conductive substrate further comprises a second series of longitudinal rows of perforations laterally offset by an electrode width;
wherein the monolithic conformal separator coating extends continuously:
across the first face and the second face of the conductive substrate; and
through the series of lateral rows of perforations and the second series of longitudinal rows of perforations; and
wherein the conductive substrate and the monolithic conformal separator coating cooperate to form a continuous electrode-separator web configured for:
resection along the series of lateral rows of perforations and along the second series of longitudinal rows of perforations to segment the continuous electrode-separator web into a set of discrete electrode-separator assemblies.

18. The system of claim 17, wherein the conductive substrate comprises:
the series of lateral rows of perforations characterized by a first open area ratio; and
the second series of longitudinal rows of perforations characterized by a second open area ratio greater than the first open area ratio.

19. A battery comprising:
a first electrode-separator assembly comprising:
a first electrode assembly:
comprising a conductive substrate; and
comprising:
a first face;
a second face opposite the first face;
a first end defining a first serrated geometry;
a second end opposite the first end defining a second serrated geometry;
a first side extending between the first end and the second end; and
a second side opposite the first side; and
a first separator:
comprising a conformal separator coating; and
extending continuously:
across the first face and the second face of the first electrode assembly;
around the first side and the second side of the first electrode assembly; and
around proximal resected regions on the first end and the second end of the first electrode assembly;
a second electrode assembly arranged over the first electrode-separator assembly; and
an electrolyte.

20. The battery of claim 19:
wherein the first electrode-separator assembly is formed by:
forming a lateral row of perforations in the conductive substrate;
applying the conformal separator coating:
across the conductive substrate; and
through the lateral row of perforations; and
resecting the conductive substrate and the conformal separator coating, following application of the conformal separator coating over the conductive substrate:
along the lateral row of perforations to form the first serrated geometry along the first end of the first electrode assembly; and
wherein the first separator:
comprises a first volume of the conformal separator coating extending across the first face of the first electrode assembly;
comprises a second volume of the conformal separator coating extending across the second face of the first electrode assembly;
comprises a third volume of the conformal separator coating:
extending around a first set of proximal resected regions on the first end of the conductive substrate corresponding to the lateral row of perforations; and
configured to resist separation of the first volume of the conformal separator coating from the first face and the second volume of the conformal separator coating from the second face proximal the first end of the first electrode assembly; and
is excluded from a first set of distal resected regions on the first end of the conductive substrate corresponding to areas of the conductive substrate between the lateral row of perforations.
